(19) United States
(12) Patent Application Publication
(10) Pub. No.: US 2026/0146116 A1
(43) Pub. Date: May 28, 2026

(54) POLYETHYLENE RESIN COMPOSITION, METHOD OF PREPARING THE SAME, AND ARTICLE PRODUCED THEREFROM

(71) Applicant: Hanwha TotalEnergies Petrochemical Co.,Ltd., Seosan-si (KR)

(72) Inventors: Eun Jin PARK, Seosan-si (KR); Jae Hyuck HAN, Seosan-si (KR); Ji Yong PARK, Seosan-si (KR)

(21) Appl. No.: 19/282,936

(22) Filed: Jul. 28, 2025

(30) Foreign Application Priority Data
Nov. 27, 2024 (KR) 10-2024-0171931

(51) Int. Cl. C08F 210/16; C08J 3/20; C08K 5/14

(52) U.S. Cl. CPC C08F 210/16; C08J 3/203; C08K 5/14; C08F 2800/20; C08J 2323/08

(57) ABSTRACT

Disclosed is a polyethylene resin composition including an ethylene copolymer containing an ethylene monomer unit and a comonomer unit, wherein the comonomer unit is contained in an amount of 2 wt % to 15 wt % based on a total weight of the ethylene copolymer, the ethylene copolymer is contained in an amount of 45 wt % to 57 wt % based on the total weight of the polyethylene resin composition, the peroxide is contained in an amount of 0.001 to 0.01 parts by weight based on 100 parts by weight of the polyethylene resin composition, and the ethylene copolymer has a melt flow index MI21.6 (21.6 kg load, 190° C.) of 0.26 g/10 min to 0.50 g/10 min.

### CROSS-REFERENCE TO THE RELATED APPLICATION

The present application claims priority to and the benefit of Korean Patent Application No. 10-2024-0171931, filed on Nov. 27, 2024, in the Korean Intellectual Property Office, the entire disclosure of which is incorporated herein by reference.

### BACKGROUND

### 1. Field

The present disclosure relates to a polyethylene resin composition having excellent sag resistance, slow crack growth resistance, pressure resistance and applicability to large-diameter pipes, a method of preparing the same, and an article produced therefrom.

### 2. Description of the Related Art

Pipes formed of polyethylene have been used as water pipes, gas pipes, industrial pipes and the like and, as slow crack growth resistance and sag resistance thereof have improved, the transition to PE100-RC grades, which have increased slow crack growth resistance (Resistant to Crack, RC) compared to PE100 grade polyethylene materials, is increasing in various applications. Since PE100-RC polyethylene has increased slow crack growth resistance, it may be applied to non-conventional installation methods (trenchless, sand bed-free technology, etc.) that can reduce installation costs and time compared to conventional installation methods.

In addition, as the importance of long-term durability increases in large-diameter pipes used for power plant cooling water transport, seawater desalination, fire pipes, energy complex terminals, d agricultural and fisheries corporations, the demand for polyethylene materials with increased slow crack growth resistance is increasing.

Typically, diameters of 800 mm or more are classified as large diameters. As the thickness increases, sagging in the direction of gravity occurs significantly during pipe processing, so polyethylene materials for large diameter pipes basically require sag resistance. This sagging phenomenon may occur not only in large diameter pipes but also in medium-diameter polyethylene pipes (diameter 630 mm) or larger. Therefore, as the polyethylene pipe market expands, polyethylene materials with high sag resistance are also required.

In general, polyethylene materials should have a molecular structure with a high degree of entanglement between tie molecules so as to increase slow crack growth resistance. For this purpose, a comonomer with a high molecular weight or a large number of carbon atoms is used. However, the slow crack growth resistance of polyethylene materials is directly related to crystallinity, i.e., density. As the density increases, the pressure resistance of the pipe improves, but there is a problem that the slow crack growth resistance significantly decreases.

On the other hand, in large-diameter pipes, there is a difference in the cooling rate of the pipe melt products during processing, causing the pipes to sag in the direction of gravity due to the weight thereof, which increases the pipe defect rate such as thickness unevenness. In order to solve this problem, enhanced sag resistance is required.

Therefore, there is a need for the development of a polyethylene resin composition that has both excellent pressure resistance and slow crack growth resistance, which are contradictory properties, and exhibits high sag resistance.

### PRIOR ART LITERATURE

### Patent Literature

Korean Patent Publication Laid-open No. 10-2020-0101872

### SUMMARY

Embodiments of the present disclosure provide a polyethylene resin composition with superior sag resistance, slow crack growth resistance, and pressure resistance.

Embodiments of the present disclosure provide a method of preparing the polyethylene resin composition.

Embodiments of the present disclosure provide an article produced from the polyethylene resin composition.

The objects to be solved by the present disclosure are not limited to the aspects mentioned above and other objects not mentioned herein will be clearly understood by those skilled in the art from the description below.

A polyethylene resin composition according to an embodiment of the present disclosure to accomplish the above object may contain an ethylene copolymer containing an ethylene monomer unit and a comonomer unit, wherein the comonomer unit is contained in an amount of 2 wt % to 15 wt % based on a total weight of the ethylene copolymer, the ethylene copolymer is contained in an amount of 45 wt % to 57 wt % based on the total weight of the polyethylene resin composition, the peroxide is contained in an amount of 0.001 to 0.01 parts by weight based on 100 parts by weight of the polyethylene resin composition, and the ethylene copolymer has a melt flow index MI21.6 (21.6 kg load, 190° C.) of 0.26 g/10 min to 0.50 g/10 min.

The comonomer may include at least one of 1-butene, 1-pentene, 4-methyl-1-pentene, 1-hexene, 1-heptene, 1-octene, 1-decene, 1-undecene, 1-dodecene, 1-tetradecene, 1-hexadecene, or 1-eicosene.

The ethylene copolymer may have a density of 0.915 g/cm³ to 0.935 g/cm³.

The polyethylene resin composition may have a zero shear viscosity (η0) of 12,000,000 poise to 50,000, 000 poise.

The peroxide in the polyethylene resin composition may include at least one selected from the group consisting of 2,5-dimethyl-2,5-di(tert-butylperoxy)hexane, 3,3,5,7,7-pentamethyl-1,2,4-trioxepane, di-tert-butyl peroxide, tert-butyl cumyl peroxide, 1,1-(tert-butylperoxy)-3,3,5-trimethylcyclohexane, n-butyl-4,4-(bis-butylperoxy) valerate, dicumyl peroxide, tert-butyl peroxide, tert-butyl peroxybenzoate, and 1,1-bis(tert-butylperoxyisopropyl)benzene.

The ethylene copolymer may have a melt index MI5 (5 kg load, 190° C.) of 0.14 g/10 min to 0.28 g/10 min.

The polyethylene resin composition may have a density of 0.956 g/cm³ to 0.962 g/cm³.

The polyethylene resin composition has a melt strength of 135 mN to 300 mN.

The polyethylene resin composition may have a drop time of 130 seconds to 200 seconds.

The polyethylene resin composition may have a CRB (crack round bar test, 12.5 MPa) of 1,500,000 cycles or more.

The polyethylene resin composition may have a strain hardening modulus of 70 MPa to 90 MPa.

The polyethylene resin composition in a pipe hydrostatic pressure test may have a fracture time of 100 hours or more at 20° C. and 12.0 MPa.

The polyethylene resin composition may have Charpy impact strength (−30° C.) of 10 KJ/m² to 25 KJ/m².

The polyethylene resin composition may be used to produce a pipe.

A method of preparing a polyethylene resin composition according to another embodiment of the present disclosure to accomplish the above object may include
preparing a polyethylene resin composition containing an ethylene copolymer in the presence of a catalyst using an ethylene monomer and a comonomer in a plurality of slurry polymerization reactors including a first reactor and a second reactor connected to each other, mixing the polyethylene resin composition with an additive including peroxide, and extruding the mixture of the polyethylene resin composition and the additive through an extruder, wherein the comonomer unit is contained in an amount of 2 wt % to 15 wt % based on a total weight of the ethylene copolymer, the ethylene copolymer is contained in an amount of 45 wt % to 57 wt % based on the total weight of the polyethylene resin composition, the peroxide is contained in an amount of 0.001 to 0.01 parts by weight based on 100 parts by weight of the polyethylene resin composition, and the ethylene copolymer has a melt flow index MI21.6 (21.6 kg load, 190° C.) of 0.26 g/10 min to 0.50 g/10 min.

The catalyst may be a Ziegler-Natta catalyst.

An article according to another embodiment of the present disclosure to accomplish the above object may be produced from the polyethylene resin composition.

The article may be a pipe.

### DETAILED DESCRIPTION OF EXEMPLARY EMBODIMENTS

The advantages and features of the present disclosure and methods of accomplishing the same will be clearly understood from the following embodiments described in detail with reference to the attached drawings. However, the present disclosure is not limited to the embodiments and may be embodied in different forms. The embodiments are suggested only to offer a thorough and complete understanding of the disclosure and to sufficiently inform those skilled in the art of the technical concept of the present disclosure and the present disclosure is defined only by the scope of claims.

Prior to the description, the meanings of terms used herein will be briefly described. However, the explanation of terms is provided for better understanding of the present disclosure and the terms should not be construed as limiting the technical idea of the present disclosure unless the context clearly indicates that the terms are used to limit the scope of the present disclosure.

The terms used herein are provided only to illustrate the exemplary embodiments and should not be construed as limiting the scope of the disclosure. Singular forms are intended to include plural forms as well, unless the context clearly indicates otherwise. It will be further understood that the terms “comprises” and/or “comprising” used herein do not preclude the presence or addition of one or more other components in addition to the mentioned components. As used herein, the term “and/or” includes any one of the enumerated items and any combination of one or more thereof. It will be understood that, although the terms “first”, “second”, etc. may be used herein to describe various elements, these elements should not be construed as being limited by these terms, which are used only to distinguish one element from another. For example, within the scope defined by the present disclosure, a first element may be referred to as a second element.

Unless defined otherwise, all terms used herein (including technical or scientific terms) have the same meanings as generally understood by those skilled in the art to which the present disclosure pertains. In addition, terms identical to those defined in generally used dictionaries should be interpreted as having meanings identical to contextual meanings of the related art, and are not interpreted as having ideal or excessively formal meanings unless they are definitely defined in the present disclosure.

Hereinafter, embodiments of the present disclosure will be described in detail.

According to one embodiment, the present disclosure provides a polyethylene resin composition. The polyethylene resin composition may contain an ethylene copolymer containing an ethylene monomer unit and a comonomer unit, wherein the comonomer unit is contained in an amount of 2 wt % to 15 wt % based on the total weight of the ethylene copolymer, the ethylene copolymer is contained in an amount of 45 wt % to 57 wt % based on the total weight of the polyethylene resin composition, the peroxide is contained in an amount of 0.001 to 0.01 parts by weight based on 100 parts by weight of the polyethylene resin composition, and the ethylene copolymer has a melt flow index MI21.6 (21.6 kg load, 190° C.) of 0.26 g/10 min to 0.50 g/10 min.

In one embodiment, the comonomer may include at least one of 1-butene, 1-pentene, 4-methyl-1-pentene, 1-hexene, 1-heptene, 1-octene, 1-decene, 1-undecene, 1-dodecene, 1-tetradecene, 1-hexadecene, or 1-eicosene. As a specific example, the comonomer may be 1-hexene.

The comonomer unit may be contained in an amount of 2 wt % to 15 wt %, 3 wt % to 12 wt %, or 3 wt % to 9 wt %, based on the total weight of the ethylene copolymer. When the ethylene copolymer contains the comonomer in an amount within the range defined above, the pressure resistance and the slow crack growth resistance may be excellent.

In one embodiment, the polyethylene resin composition may contain the ethylene copolymer in an amount of 45 wt % to 57 wt %, or 47 wt % to 57 wt %, based on the total weight of the polyethylene resin composition. The polyethylene resin composition containing the ethylene copolymer in the amount within the range described above may exhibit excellent sag resistance, slow crack growth resistance, and pressure resistance.

In one embodiment, the ethylene copolymer may have a melt index MI21.6 (21.6 kg load, 190° C.) of 0.26 g/10 min to 0.50 g/10 min, 0.26 g/10 min to 0.45 g/10 min, or 0.28 g/10 min to 0.40 g/10 min. The melt index MI21.6 of the ethylene copolymer is measured at 190° C. with a 21.6 kg load using an orifice having an inner diameter of 2.75 mm. When the polyethylene resin composition contains the ethylene copolymer having a melt index MI21.6 within the range described above, it may exhibit excellent slow crack growth resistance and pressure resistance, as well as improved appearance.

In one embodiment, the density of the ethylene copolymer may be 0.915 g/cm³ to 0.935 g/cm³, 0.915 g/cm³ to 0.923 g/cm³, or 0.917 g/cm³ to 0.921 g/cm³. When the polyethylene resin composition contains the ethylene copolymer having a density within the range described above, it may simultaneously exhibit excellent pressure resistance and slow crack growth resistance of the pipe.

In one embodiment, the polyethylene resin composition may have a melt index MI5 (5 kg load, 190° C.) of 0.14 g/10 min to 0.28 g/10 min, 0.15 g/10 min to 0.24 g/10 min, 0.15 g/10 min to 0.22 g/10 min, or 0.15 g/10 min to 0.20 g/10 min. The melt index MI5 of the polyethylene resin composition is measured at 190° C. with a 5 kg load using an orifice having an inner diameter of 2.095 mm, and the polyethylene resin composition may have excellent sag resistance, melt strength, and processability because it has a melt index MI5 within the range described above.

In one embodiment, the density of the polyethylene resin composition may be 0.956 g/cm³ to 0.962 g/cm³, 0.956 g/cm³ to 0.960 g/cm³, 0.956 g/cm³ to 0.959 g/cm³, or 0.957 g/cm³ to 0.959 g/cm³. The polyethylene resin composition having a density within the range described above can prevent sagging of the pipe and simultaneously exhibit excellent pressure resistance and slow crack growth resistance.

In one embodiment, the zero shear viscosity (n0) of the polyethylene resin composition may be 12,000,000 poise to 50,000,000 poise, 15,000,000 poise to 35,000,000 poise, 20,000,000 poise to 35,000,000 poise, or 25,000, 000 poise to 35,000,000 poise. The zero shear viscosity may be obtained by measuring the storage modulus and the loss modulus depending on the shear rate (unit: rad/sec). When the zero shear viscosity of the polyethylene resin composition falls within the range described above, problem of sagging due to thickness imbalance that occurs when the polyethylene resin composition flows in the direction of gravity before cooling during pipe extrusion processing can be solved.

In one embodiment, the polyethylene resin composition may contain an additive including peroxide. The peroxide may include at least one selected from the group consisting of 2,5-dimethyl-2,5-di(tert-butylperoxy)hexane, 3,3,5,7,7-pentamethyl-1,2,4-trioxepane, di-tert-butyl peroxide, tert-butyl cumyl peroxide, 1,1-(tert-butylperoxy)-3,3,5-trimethylcyclohexane, n-butyl-4,4-(bis-butylperoxy) valerate, dicumyl peroxide, tert-butyl peroxide, tert-butyl peroxybenzoate, and 1,1-bis(tert-butylperoxyisopropyl)benzene. As a specific example, the peroxide may include at least one selected from the group consisting of 2,5-dimethyl-2,5-di(tert-butylperoxy)hexane, 3,3,5,7,7-pentamethyl-1,2,4-trioxepane, di-tert-butyl peroxide, and tert-butyl cumyl peroxide.

The content of the peroxide may be 0.001 to 0.01 parts by weight, 0.001 to 0.008 parts by weight, or 0.002 to 0.007 parts by weight, based on 100 parts by weight of the polyethylene resin composition. When the content of the peroxide falls within the range described above, sagging may be prevented and processability may be improved.

In one embodiment, the additive may further include at least one selected from the group consisting of an antioxidant and a neutralizer. The contents of the antioxidant and the neutralizer may be appropriately adjusted to amounts commonly used in the art. For example, the antioxidant and the neutralizer may be contained in an amount of 0.1 to 5 parts by weight based on 100 parts by weight of the polyethylene resin composition.

The types of the antioxidant are not particularly limited, but the antioxidant includes at least one selected from the group consisting of 1,3,5-trimethyl-2,4,6-tris(3,5-di-tert-butyl-4-hydroxybenzyl)benzene, 1,6-bis[3-(3,5-di-tert-butyl-4-hydroxyphenyl)propionamido]hexane, 1,6-bis[3-(3,5-di-tert-butyl-4-hydroxyphenyl)propionamido]propane, tetrakis[methylene (3,5-di-tert-butyl-4-hydroxyhydrocinnamate)]methane, pentaerythritol-tetrakis(3-(3,5-di-tert-butyl-4-hydroxyphenol)propionate), 1,3,5-tris(3,5-di-tert-butyl-4-hydroxybenzyl)-1,3,5-triazinane-2,4,6-trione, bis(octadecyl) hydroxyamine, tris(2,4-di-tert-butylphenyl)-phosphite, bis(2,6-di-tert-butyl-4-methylphenyl)pentaerythritol-di-phosphite and bis(2,4-di-tert-butylphenyl)pentaerythritol-di-phosphite. As a specific example, the antioxidant may be a mixture of pentaerythritol-tetrakis(3-(3,5-di-tert-butyl-4-hydroxyphenol)propionate) and tris(2,4-di-tert-butylphenyl)-phosphite.

The antioxidant may be contained in an amount of 0.1 to 5 parts by weight, or 0.2 to 0.4 parts by weight, based on 100 parts by weight of the polyethylene resin composition. When the antioxidant is present in an amount within the range described above, corrosion and discoloration due to oxidation of the pipe may be prevented.

The type of the neutralizer is not particularly limited, but the neutralizer may include at least one selected from the group consisting of calcium stearate, zinc stearate, magnesium aluminum hydroxy carbonate, zinc oxide, and magnesium hydroxy stearate. As a specific example, the neutralizer may be calcium stearate.

The neutralizer may be contained in an amount of 0.01 to 0.3 parts by weight, or 0.1 to 0.2 parts by weight, based on 100 parts by weight of the polyethylene resin composition. When the neutralizer is present in an amount within the range defined above, the resistance to sagging of the pipe, the resistance to slow crack growth, and the processability may be improved.

In one embodiment, the melt strength of the prepared polyethylene resin composition may be 135 mN to 300 mN, 135 mN to 250 mN, 145 mN to 240 mN or 155 mN to 230 mN. The melt strength may be obtained by measuring the force that stabilizes as the speed of pulling the resin is increased at a resin temperature of 200° C. and a chamber temperature of 180° C. When the melt strength of the polyethylene resin composition falls within the above range, the polyethylene resin may exhibit excellent sag resistance during pipe processing, specifically, during large-diameter pipe processing, and thus is useful for large-diameter pipes.

In one embodiment, the drop time of the polyethylene resin composition may be 130 seconds to 200 seconds, 135 seconds to 195 seconds, or 140 seconds to 190 seconds. The time (drop time, seconds) for the extruded melt product to reach the ground may be measured when extruded to a height of 90.5 cm from the ground under the conditions of an extrusion temperature of 200° C., an extrusion amount of 38.1 g/min, and an initial linear velocity of 0.546 cm/sec through a single-screw extruder so as to evaluate the degree of sagging. When the drop time falls within the range, excellent sag resistance may be achieved during pipe processing, specifically, during large-diameter pipe processing, and thus the polyethylene resin composition is useful for large-diameter pipes.

The polyethylene resin composition may have a CRB (crack round bar test, 12.5 MPa) of 1,500,000 cycles or more, 1,500,000 cycles to 3,500,000 cycles, 1,700,000 cycles to 3,000,000 cycles, or 1,800,000 cycles to 2,500,000 cycles. When the CRB falls within the above-mentioned range, the slow crack growth resistance is excellent, so that the pipe can be easily manufactured by applying an unconventional installation technique.

The polyethylene resin composition may have a strain hardening modulus of 70 MPa to 90 MPa, 75 MPa to 90 MPa, or 75 MPa to 85 MPa. When the strain hardening modulus falls within the above-mentioned range, as the slow crack growth resistance is improved, a pipe having excellent long-term stability can be provided.

In one embodiment, the fracture time of the prepared polyethylene resin composition in the pipe hydrostatic pressure test may be 100 hours or more, 150 hours or more, or 100 hours to 500 hours under the conditions of 20° C. and 12.0 MPa. The pressure resistance of the pipe is measured in accordance with ISO 1167, and specifically, the fracture time may be measured under the conditions of a hoop stress of 12.0 MPa at 20° C. after produced into a pipe having a dn size of 32 mm (SDR11). When the fracture time is less than 100 hours, the minimum required strength standard for PE100 material is not satisfied, thus being inapplicable to gas pipes, water pipes, and the like.

The Charpy impact strength (−30° C.) of the polyethylene resin composition may be 10 KJ/m² to 25 KJ/m², 15 KJ/m² to 25 KJ/m², or 15 KJ/m² to 20 KJ/m². When the Charpy impact strength falls within the above-mentioned range, a pipe having excellent impact strength can be produced.

In one embodiment, the polyethylene resin composition may be used for pipe manufacturing, specifically, for large-diameter pipe manufacturing.

Since the above-described polyethylene resin composition has excellent sag resistance, slow crack growth resistance, and pressure resistance, it may be useful for large-diameter pipes.

In one embodiment, the present disclosure provides a method of preparing the polyethylene resin composition. The method of preparing the polyethylene resin composition includes preparing a polyethylene resin composition containing an ethylene copolymer in the presence of a catalyst using an ethylene monomer and a comonomer in a plurality of slurry polymerization reactors including a first reactor and a second reactor connected to each other, mixing the polyethylene resin composition with an additive including peroxide, and extruding the mixture of the polyethylene resin composition and the additive through an extruder, wherein the comonomer unit is contained in an amount of 2 wt % to 15 wt % based on the total weight of the ethylene copolymer, the ethylene copolymer is contained in an amount of 45 wt % to 57 wt % based on the total weight of the polyethylene resin composition, the peroxide is contained in an amount of 0.001 to 0.01 parts by weight based on 100 parts by weight of the polyethylene resin composition, and the ethylene copolymer has a melt flow index MI21.6 (21.6 kg load, 190° C.) of 0.26 g/10 min to 0.50 g/10 min.

In one embodiment, the catalyst may be a Ziegler-Natta catalyst. The slurry polymerization reaction may be performed in the presence of a Ziegler-Natta catalyst. Specifically, the polyethylene resin composition may be prepared by performing slurry polymerization in a two-stage polymerization manner using the first reactor and the second reactor connected in series by feeding an ethylene monomer and a comonomer in the presence of a Ziegler-Natta catalyst.

The Ziegler-Natta catalyst is a known conventional Ziegler-Natta catalyst. A transition metal compound belonging to Group IV, Group V, or Group VI of the Periodic Table may be used as a main catalyst. Among them, the most commonly used Ziegler-Natta catalyst is a halogenated complex containing magnesium and titanium, or magnesium and vanadium.

The comonomer may include at least one of 1-butene, 1-pentene, 4-methyl-1-pentene, 1-hexene, 1-heptene, 1-octene, 1-decene, 1-undecene, 1-dodecene, 1-tetradecene, 1-hexadecene, or 1-eicosene. As a specific example, the comonomer may be 1-hexene.

The comonomer unit may be contained in an amount of 2 wt % to 15 wt %, 3 wt % to 12 wt %, or 3 wt % to 9 wt %, based on the total weight of the ethylene copolymer. When the ethylene copolymer contains the comonomer in an amount within the range defined above, the pressure resistance and the slow crack growth resistance may be excellent.

In one embodiment, the prepared polyethylene resin composition may contain the ethylene copolymer in an amount of 45 wt % to 57 wt %, or 47 wt % to 57 wt %, based on the total weight of the polyethylene resin composition. The polyethylene resin composition containing an ethylene copolymer in the amount within the range defined above may exhibit excellent sag resistance, slow crack growth resistance, and pressure resistance.

In one embodiment, the prepared ethylene copolymer may have a melt index MI21.6 (21.6 kg load, 190° C.) of 0.26 g/10 min to 0.50 g/10 min, 0.26 g/10 min to 0.45 g/10 min, or 0.28 g/10 min to 0.40 g/10 min. The melt index MI21.6 of the ethylene copolymer is measured at 190° C. with a 21.6 kg load using an orifice having an inner diameter of 2.75 mm. When the polyethylene resin composition contains the ethylene copolymer having a melt index MI21.6 within the range described above, it may exhibit excellent slow crack growth resistance and pressure resistance, as well as improved appearance.

In one embodiment, the density of the ethylene copolymer contained in the prepared polyethylene resin composition may be 0.915 g/cm³ to 0.935 g/cm³, 0.915 g/cm³ to 0.923 g/cm³, or 0.917 g/cm³ to 0.921 g/cm³. When the polyethylene resin composition contains the ethylene copolymer having a density within the range described above, it may simultaneously exhibit excellent pressure resistance and slow crack growth resistance of the pipe.

In one embodiment, the polyethylene resin composition may have a melt index MI5 (5 kg load, 190° C.) of 0.14 g/10 min to 0.28 g/10 min, 0.15 g/10 min to 0.24 g/10 min, 0.15 g/10 min to 0.22 g/10 min, or 0.15 g/10 min to 0.20 g/10 min. The melt index MI5 of the polyethylene resin composition is measured at 190° C. with a 5 kg load using an orifice having an inner diameter of 2.095 mm, and the polyethylene resin composition may have excellent sag resistance, melt strength, and processability because it has a melt index MI5 within the range described above.

In one embodiment, the density of the polyethylene resin composition may be 0.956 g/cm³ to 0.962 g/cm³, 0.956 g/cm³ to 0.960 g/cm³, 0.956 g/cm³ to 0.959 g/cm³, or 0.957 g/cm³ to 0.959 g/cm³. The polyethylene resin composition having a density within the range described above can prevent sagging of the pipe and simultaneously exhibit excellent pressure resistance and slow crack growth resistance.

In one embodiment, the zero shear viscosity (n0) of the polyethylene resin composition may be 12,000,000 poise to 50,000,000 poise, 15,000,000 poise to 35,000,000 poise, 20,000,000 poise to 35,000,000 poise, or 25,000,000 poise to 35,000,000 poise. The zero shear viscosity may be obtained by measuring the storage modulus and the loss modulus depending on the shear rate (unit: rad/sec). When the zero shear viscosity of the polyethylene resin composition falls within the range described above, problem of sagging due to thickness imbalance that occurs when the polyethylene resin composition flows in the direction of gravity before cooling during pipe extrusion processing can be solved.

In one embodiment, in the step of mixing the polyethylene resin composition with the additive including peroxide, the peroxide may include at least one selected from the group consisting of 2,5-dimethyl-2,5-di(tert-butylperoxy)hexane, 3,3,5,7,7-pentamethyl-1,2,4-trioxepane, di-tert-butyl peroxide, tert-butyl cumyl peroxide, 1,1-(tert-butylperoxy)-3,3,5-trimethylcyclohexane, n-butyl-4,4-(bis-butylperoxy) valerate, dicumyl peroxide, tert-butyl peroxide, tert-butyl peroxybenzoate, and 1,1-bis(tert-butylperoxyisopropyl)benzene. As a specific example, the peroxide may include at least one selected from the group consisting of 2,5-dimethyl-2,5-di(tert-butylperoxy)hexane, 3,3,5,7,7-pentamethyl-1,2,4-trioxepane, di-tert-butyl peroxide, and tert-butyl cumyl peroxide.

The content of the peroxide may be 0.001 to 0.01 parts by weight, 0.001 to 0.008 parts by weight, or 0.002 to 0.007 parts by weight, based on 100 parts by weight of the polyethylene resin composition. When the content of the peroxide falls within the range described above, sagging may be prevented and processability may be improved.

In one embodiment, the additive may further include at least one selected from the group consisting of an antioxidant and a neutralizer. The contents of the antioxidant and the neutralizer may be appropriately adjusted to amounts commonly used in the art. For example, the antioxidant and the neutralizer may be contained in an amount of 0.1 to 5 parts by weight based on 100 parts by weight of the polyethylene resin composition.

The types of the antioxidant are not particularly limited, but the antioxidant includes at least one selected from the group consisting of 1,3,5-trimethyl-2,4,6-tris(3,5-di-tert-butyl-4-hydroxybenzyl)benzene, 1,6-bis[3-(3,5-di-tert-butyl-4-hydroxyphenyl)propionamido]hexane, 1,6-bis[3-(3,5-di-tert-butyl-4-hydroxyphenyl)propionamido]propane, tetrakis[methylene (3,5-di-tert-butyl-4-hydroxyhydrocinnamate)]methane, pentaerythritol-tetrakis(3-(3,5-di-tert-butyl-4-hydroxyphenol)propionate), 1,3,5-tris(3,5-di-tert-butyl-4-hydroxybenzyl)-1,3,5-triazinane-2,4,6-trione, bis(octadecyl) hydroxyamine, tris(2,4-di-tert-butylphenyl)-phosphite, bis(2,6-di-tert-butyl-4-methylphenyl)pentaerythritol-di-phosphite and bis(2,4-di-tert-butylphenyl)pentaerythritol-di-phosphite. As a specific example, the antioxidant may be a mixture of pentaerythritol-tetrakis(3-(3,5-di-tert-butyl-4-hydroxyphenol)propionate) and tris(2,4-di-tert-butylphenyl)-phosphite.

The antioxidant may be contained in an amount of 0.1 to 5 parts by weight, or 0.2 to 0.4 parts by weight, based on 100 parts by weight of the polyethylene resin composition. When the antioxidant is present in an amount within the range described above, corrosion and discoloration due to oxidation of the pipe may be prevented.

The type of the neutralizer is not particularly limited, but the neutralizer may include at least one selected from the group consisting of calcium stearate, zinc stearate, magnesium aluminum hydroxy carbonate, zinc oxide, and magnesium hydroxy stearate. As a specific example, the neutralizer may be calcium stearate.

The neutralizer may be contained in an amount of 0.01 to 0.3 parts by weight, or 0.1 to 0.2 parts by weight, based on 100 parts by weight of the polyethylene resin composition. When the neutralizer is present in an amount within the range defined above, the resistance to sagging of the pipe, the resistance to slow crack growth, and the processability may be improved.

In one embodiment, the melt strength of the prepared polyethylene resin composition may be 135 mN to 300 mN, 135 mN to 250 mN, 145 mN to 240 mN or 155 mN to 230 mN. The melt strength may be obtained by measuring the force that stabilizes as the speed of pulling the resin is increased at a resin temperature of 200° C. and a chamber temperature of 180° C. When the melt strength of the polyethylene resin composition falls within the above range, the polyethylene resin may exhibit excellent sag resistance during pipe processing, specifically, during large-diameter pipe processing, and thus is useful for large-diameter pipes.

In one embodiment, the drop time of the prepared polyethylene resin composition may be 130 seconds to 200 seconds, 135 seconds to 195 seconds, or 140 seconds to 190 seconds. The time (drop time, seconds) for the extruded melt product to reach the ground may be measured when extruded to a height of 90.5 cm from the ground under the conditions of an extrusion temperature of 200° C., an extrusion amount of 38.1 g/min, and an initial linear velocity of 0.546 cm/sec through a single-screw extruder so as to evaluate the degree of sagging. When the drop time falls within the range, excellent sag resistance may be achieved during pipe processing, specifically, during large-diameter pipe processing, and thus the polyethylene resin composition is useful for large-diameter pipes.

The polyethylene resin composition may have a CRB (crack round bar test, 12.5 MPa) of 1,500,000 cycles or more, 1,500,000 cycles to 3,500,000 cycles, 1,700,000 cycles to 3,000,000 cycles, or 1,800,000 cycles to 2,500,000 cycles. When the CRB falls within the above-mentioned range, the slow crack growth resistance is excellent, so that the pipe can be easily manufactured by applying an unconventional installation technique.

The polyethylene resin composition may have a strain hardening modulus of 70 MPa to 90 MPa, 75 MPa to 90 MPa, or 75 MPa to 85 MPa. When the strain hardening modulus falls within the above-mentioned range, as the slow crack growth resistance is improved, a pipe having excellent long-term stability can be provided.

In one embodiment, the fracture time of the prepared polyethylene resin composition in the pipe hydrostatic pressure test may be 100 hours or more, 150 hours or more, or 100 hours to 500 hours under the conditions of 20° C. and 12.0 MPa. The pressure resistance of the pipe is measured in accordance with ISO 1167, and specifically, the fracture time may be measured under the conditions of a hoop stress of 12.0 MPa at 20° C. after produced into a pipe having a dn size of 32 mm (SDR11). When the fracture time is less than 100 hours, the minimum required strength standard for PE100 material is not satisfied, thus being inapplicable to gas pipes, water pipes, and the like.

The Charpy impact strength (−30° C.) of the polyethylene resin composition may be 10 kJ/m² to 25 KJ/m², 15 KJ/m² to 25 KJ/m², or 15 KJ/m² to 20 KJ/m². When the Charpy impact strength falls within the above-mentioned range, a pipe having excellent impact strength can be produced.

In one embodiment, in the step of extruding the mixture of the polyethylene resin composition and the additive, the extruder may be a single-screw extruder or a twin-screw extruder. As a specific example, the extruder may be a twin-screw extruder and may include a screw having a diameter of 500 mm to 800 mm, 550 mm to 750 mm, or 550 mm to 650 mm, and an L/D (screw length/screw diameter) of 5 to 10, or 7 to 10.

The extruder may be operated under the conditions of a temperature of 200° C. to 300° C., 210° C. to 270° C., or 230° C. to 250° C. and a screw rotation speed of 1,000 rpm to 1,300 rpm, 1,000 rpm to 1,200 rpm, or 1,050 rpm to 1,150 rpm.

In addition, according to one embodiment, the present disclosure provides an article produced from the polyethylene resin composition described above.

The article may be, for example, a pipe. The polyethylene resin composition described above has excellent sag resistance, slow crack growth resistance, and pressure resistance and thus may be useful for pipes.

As a specific example, the article may be a large-diameter pipe for water pipes, gas pipes, industrial pipes and the like. The polyethylene resin composition described above may be useful for large-diameter pipes because it has excellent sag resistance, slow crack growth resistance, and pressure resistance.

Hereinafter, specific examples of the present disclosure will be described. However, the examples described below are only provided to exemplify or illustrate the present disclosure in detail and should not be construed as limiting the scope of the present disclosure. In addition, other details that may be sufficiently conceived by those skilled in the art will not be described.

### (Preparation of Polyethylene Resin Composition)

### EXAMPLE

### Example 1

Two-stage polymerization was performed through continuous slurry polymerization using a first reactor and a second reactor connected in series, a Ziegler-Natta catalyst was used as a catalyst, and 1-hexene was used as a comonomer.

The ethylene copolymer obtained in the first reactor had a melt index MI21.6 of 0.30 g/10 min, a density of 0.919 g/cm³, a polymerization ratio in the first reactor of 51 wt % and a copolymer content was 5 wt %.

The reaction product obtained from the first reactor was supplied to the second reactor and participated in the reaction, and 100 parts by weight of the powdered polyethylene resin obtained from the reaction product of the second reactor was mixed with 0.15 parts by weight of Irganox 1010 and 0.15 parts by weight of Irgafos-168 as antioxidants, 0.15 parts by weight of calcium stearate as a neutralizer, and 0.003 parts by weight of 2,5-dimethyl-2,5-di(tert-butylperoxy)hexane as peroxide using a Henschel mixer, and then a polyethylene resin composition was prepared in the form of a pellet using a twin screw extruder. At this time, the twin screw extruder had a screw having a diameter of 608 mm and a L/D (screw length/screw diameter) of 8, and was operated at a temperature of 240° C. and a speed of 1,090 rpm.

The prepared polyethylene resin composition had a melt index MI5 of 0.19 g/10 min, a density of 0.957 g/cm³, and a zero shear viscosity of 29,000,000 poise.

### Example 2

Two-stage polymerization was performed through continuous slurry polymerization using a first reactor and a second reactor connected in series, a Ziegler-Natta catalyst was used as a catalyst, and 1-hexene was used as a comonomer.

The ethylene copolymer obtained in the first reactor had a melt index MI21.6 of 0.35 g/10 min, a density of 0.920 g/cm³, a polymerization ratio in the first reactor of 51 wt % and a copolymer content was 7.5 wt %.

The reaction product obtained from the first reactor was supplied to the second reactor and participated in the reaction, and 100 parts by weight of the powdered polyethylene resin obtained from the reaction product of the second reactor was mixed with 0.15 parts by weight of Irganox 1010 and 0.15 parts by weight of Irgafos-168 as antioxidants, 0.15 parts by weight of calcium stearate as a neutralizer, and 0.004 parts by weight of 2,5-dimethyl-2,5-di(tert-butylperoxy)hexane as peroxide using a Henschel mixer, and then a polyethylene resin composition was prepared in the form of a pellet using a twin screw extruder.

The polyethylene resin composition had a melt index MI5 of 0.17 g/10 min, a density of 0.958 g/cm³, and a zero shear viscosity of 32,000,000 poise.

### COMPARATIVE EXAMPLE

### Comparative Example 1

A polyethylene resin composition was prepared in the same manner as Example 1 except that the composition and the conditions shown in Table 1 below were used.

Compared to Example 1, the ethylene copolymer obtained by adjusting the polymerization ratio of the ethylene copolymer in the first reactor to 51 wt % and adjusting the copolymer content to 5.5 wt % had a melt index MI21.6 of 0.35 g/10 min and a density of 0.920 g/cm³. The pellet-type polyethylene resin composition prepared without adding peroxide to the powdered polyethylene resin obtained from the second reactor had a melt index MI5 of 0.20 g/10 min, a density of 0.958 g/cm³ and a zero shear viscosity of 13,000,000 poise.

### Comparative Example 2

A polyethylene resin composition was prepared in the same manner as Example 1 except that the composition and the conditions shown in Table 1 below were used.

Compared to Example 1, the ethylene copolymer obtained by adjusting the polymerization ratio of the ethylene copolymer in the first reactor to 51 wt % and adjusting the copolymer content to 5.8 wt % had a melt index MI21.6 of 0.35 g/10 min and a density of 0.920 g/cm³. The pellet-type polyethylene resin composition prepared by adding 0.011 parts by weight of 2,5-dimethyl-2,5-di(tert-butylperoxy)hexane as peroxide to 100 parts by weight of the powdered polyethylene resin obtained from the second reactor had a melt index MI5 of 0.15 g/10 min, a density of 0.958 g/cm³ and a zero shear viscosity of 30,500,000 poise.

### Comparative Example 3

A polyethylene resin composition was prepared in the same manner as Example 1 except that the composition and the conditions shown in Table 1 below were used.

Compared to Example 1, the ethylene copolymer obtained by adjusting the polymerization ratio of the ethylene copolymer in the first reactor to 49 wt % and adjusting the copolymer content to 2.8 wt % had a melt index MI21.6 of 0.51 g/10 min and a density of 0.925 g/cm³. The pellet-type polyethylene resin composition prepared by adding 0.0045 parts by weight of 2,5-dimethyl-2,5-di(tert-butylperoxy)hexane as peroxide to 100 parts by weight of the powdered polyethylene resin obtained from the second reactor had a melt index MI5 of 0.18 g/10 min, a density of 0.958 g/cm³ and a zero shear viscosity of 22,000,000 poise.

### Comparative Example 4

A polyethylene resin composition was prepared in the same manner as Example 1 except that the composition and the conditions shown in Table 1 below were used.

Compared to Example 1, the ethylene copolymer obtained by adjusting the polymerization ratio of the ethylene copolymer in the first reactor to 50 wt % and adjusting the copolymer content to 9.2 wt % had a melt index MI21.6 of 0.25 g/10 min and a density of 0.917 g/cm³. The pellet-type polyethylene resin composition prepared by adding 0.004 parts by weight of 2,5-dimethyl-2,5-di(tert-butylperoxy)hexane as peroxide to 100 parts by weight of the powdered polyethylene resin obtained from the second reactor had a melt index MI5 of 0.14 g/10 min, a density of 0.954 g/cm³ and a zero shear viscosity of 34,000,000 poise.

### Comparative Example 5

A polyethylene resin composition was prepared in the same manner as Example 1 except that the composition and the conditions shown in Table 1 below were used.

Compared to Example 1, the ethylene copolymer obtained by adjusting the polymerization ratio of the ethylene copolymer in the first reactor to 44 wt % and adjusting the copolymer content to 6 wt % had a melt index MI21.6 of 0.48 g/10 min and a density of 0.924 g/cm³. The pellet-type polyethylene resin composition prepared by adding 0.0045 parts by weight of 2,5-dimethyl-2,5-di(tert-butylperoxy)hexane as peroxide to 100 parts by weight of the powdered polyethylene resin obtained from the second reactor had a melt index MI5 of 0.26 g/10 min, a density of 0.960 g/cm³ and a zero shear viscosity of 11,000,000 poise.

### Comparative Example 6

A polyethylene resin composition was prepared in the same manner as Example 1 except that the composition and the conditions shown in Table 1 below were used.

Compared to Example 1, the ethylene copolymer obtained by adjusting the polymerization ratio of the ethylene copolymer in the first reactor to 58 wt % and adjusting the copolymer content to 5.5 wt % had a melt index MI21.6 of 0.48 g/10 min and a density of 0.919 g/cm³. The pellet-type polyethylene resin composition prepared by adding 0.002 parts by weight of 2,5-dimethyl-2,5-di(tert-butylperoxy)hexane as peroxide to 100 parts by weight of the powdered polyethylene resin obtained from the second reactor had a melt index MI5 of 0.17 g/10 min, a density of 0.955 g/cm³ and a zero shear viscosity of 32,000,000 poise.

TABLE 1

| | | Example | | Comparative Example | | | | | |
|---|---|---|---|---|---|---|---|---|---|
| | | 1 | 2 | 1 | 2 | 3 | 4 | 5 | 6 |
| First | MI21.6 | 0.3 | 0.35 | 0.35 | 0.35 | 0.51 | 0.25 | 0.48 | 0.48 |
| reactor | (g/10 min) | | | | | | | | |
| | Polymerization | 51 | 51 | 51 | 51 | 49 | 50 | 44 | 58 |
| | ratio | | | | | | | | |
| | (wt %) | | | | | | | | |
| | Comonomer | 5 | 7.5 | 5.5 | 5.8 | 2.8 | 9.2 | 6 | 5.5 |
| | content | | | | | | | | |
| | (wt %) | | | | | | | | |
| | Density | 0.919 | 0.92 | 0.92 | 0.92 | 0.925 | 0.917 | 0.924 | 0.919 |
| | (g/cm³) | | | | | | | | |

### Test 1: Measurement of Properties of Polyethylene Resin Compositions

The following properties of the polyethylene resin compositions prepared in Examples 1 and 2 and Comparative Examples 1 to 6 were measured and the results are shown in Table 2 below.

### Melt Index (MI)

The melt index MI21.6 was measured at 190° C. under a load of 21.6 kg (orifice with inner diameter of 2.75 mm) in accordance with ASTM D1238.

The melt index MI5 was measured at 190° C. under a load of 5 kg (orifice with inner diameter of 2.095 mm) in accordance with ASTM D1238.

### Density

Measured according to ASTM D1505.

### Zero Shear Viscosity (η0)

The storage modulus (G′) and loss modulus (G″) were measured in accordance with the shear rate (unit: rad/sec) using ARES (advanced rheometer expansion system, 190° C.) and the zero shear viscosity (n0) was calculated by applying the resulting values to the Carreau model.

### Drop Time

A HAAKE Rheomex OS single screw extruder was used and a bar-shaped die with a diameter of 12 mm was used. The temperature for processing was 200° C., the extrusion amount was maintained at 38.1 g/min, the initial line velocity of the extruded resin was 0.546 cm/sec, and the height to the ground was 90.5 cm. The time (drop time, seconds) for the extruded melt product of each polyethylene resin composition to reach the ground was measured.

### Melt Strength

The stabilizing force was measured as the speed at which the resin was pulled increased at a resin temperature of 200° C. and a chamber temperature of 180° C.

### Fatigue Test (Crack Round Bar Test, CRB)

Fatigue was measured in accordance with ISO 18489 and was evaluated within the target stress range of 11.5 MPa to 13.5 MPa, and the number of cycles was determined by extrapolation when the stress was 12.5 MPa.

### Strain Hardening Modulus (SHM)

Measured in accordance with ISO 18488.

### Charpy Impact Strength

Measured at −30° C. in accordance with ISO 179/1Ea using specimens satisfying ISO 1872-2 conditions.

### Hydrostatic Pressure Test

A pipe with a dn of 32 mm and a SDR11 size was formed using the polyethylene resin composition in accordance with ISO 1167, and the fracture time was measured under the conditions of a hoop stress of 12.0 MPa at 20° C.

### Appearance

A pipe with a dn of 32 mm (SDR11) or dn of 110 mm (SDR11) was produced from the polyethylene resin composition using a pipe extruder (uniEX 35-30C) from Battenfeld-Cincinnati, and the outer and inner surfaces of the produced pipe were visually observed to evaluate the appearance based on the following criteria.

### [Test Criteria]

o: When the surface is smooth and normal
x: When the surface is rough and has unevenness

TABLE 2

| | Example | | Comparative Example | | | | | |
|---|---|---|---|---|---|---|---|---|
| | 1 | 2 | 1 | 2 | 3 | 4 | 5 | 6 |
| Peroxide | 0.003 | 0.004 | 0 | 0.011 | 0.0045 | 0.004 | 0.0045 | 0.002 |
| content | | | | | | | | |
| (parts by | | | | | | | | |
| weight) | | | | | | | | |
| MI5 | 0.19 | 0.17 | 0.20 | 0.15 | 0.18 | 0.14 | 0.26 | 0.17 |
| (g/10 min) | | | | | | | | |
| Density | 0.957 | 0.958 | 0.958 | 0.958 | 0.958 | 0.954 | 0.960 | 0.955 |
| (g/cm³) | | | | | | | | |
| Zero | 29 | 32 | 13 | 30.5 | 22 | 34 | 11 | 32 |
| shear | | | | | | | | |
| viscosity | | | | | | | | |
| (poise ×10⁶) | | | | | | | | |
| Drop time | 148 | 151 | 128 | 205 | 140 | 151 | 129 | 152 |
| (sec) | | | | | | | | |
| Melt | 210 | 218 | 130 | 255 | 200 | 220 | 190 | 215 |
| strength | | | | | | | | |
| (mN) | | | | | | | | |
| CRB | 158 | 180 | 155 | — | 120 | 240 | 115 | 158 |
| (Number | | | | | | | | |
| of | | | | | | | | |
| cycles ×10⁴) | | | | | | | | |
| SHM | 78 | 85 | 78 | — | 76 | 77 | 69 | 77 |
| (MPa) | | | | | | | | |
| Impact | 17 | 18 | 15 | — | 12 | 16 | 11 | 15 |
| strength | | | | | | | | |
| (kJ/m²) | | | | | | | | |
| Hydrostatic | >100 | >100 | >100 | — | >100 | 60 | >100 | 70 |
| pressure | | | | | | | | |
| test (hr) | | | | | | | | |
| Appearance | ◯ | ◯ | ◯ | X | ◯ | X | ◯ | ◯ |

As can be seen from Table 2 above, Comparative Example 1 does not fall within the range of the polyethylene resin composition for pipes according to the embodiment due to omission of addition of peroxide. In this case, the zero shear viscosity is 13,000,000 poise, the drop time is 128 seconds, and the melt strength is 130 mN, which means that the zero shear viscosity and the melt strength are greatly reduced compared to Examples 1 and 2, and thus the sag resistance is very poor.

Comparative Example 2 does not fall within the range of the polyethylene resin composition for pipes according to the embodiment because the peroxide is contained in an amount of 0.011 parts by weight. In this case, the drop time is 205 seconds, and the melt strength is 255 mN, which means that the appearance is very poor compared to Examples 1 and 2, thus being inapplicable to production of specimens for evaluating the physical properties.

In Comparative Example 3, a melt flow index MI21.6 of the ethylene copolymer is 0.51 g/10 min, a comonomer content is 2.8 wt %, and a density is 0.925 g/cm³, which are outside the ranges of the polyethylene resin composition for pipes according to one embodiment. In this case, it can be seen that the CRB is 120×10⁴ cycles, slow crack growth resistance is greatly reduced compared to Examples 1 and 2, and the impact strength is also reduced.

In Comparative Example 4, a melt flow index MI21.6 of the ethylene copolymer is 0.25 g/10 min, a comonomer content is 9.2 wt %, a density is 0.917 g/cm³, a MI5 of the pellet-type prepared polyethylene resin composition is 0.14 g/10 min, and a density of the pellet-type prepared polyethylene resin composition is 0.954 g/cm³, which are outside the ranges of the polyethylene resin composition for pipes according to one embodiment. In this case, it can be seen that the fracture time in the hydrostatic pressure test is 60 hours, which was significantly reduced than compared to Examples 1 and 2, and appearance problem also occurred.

In Comparative Example 5, the density of the pellet-type polyethylene resin composition prepared with a polymerization ratio of the ethylene copolymer of 44 wt % has a MI5 of 0.26 g/10 min, which is outside the range of the polyethylene resin composition for pipes according to one embodiment. In this case, the zero shear viscosity was 11,000,000 poise, the drop time reduction rate was 22%, the CRB was 115×10⁴ cycles, the SHM was 69 MPa, the slow crack growth resistance was significantly reduced compared to Examples 1 and 2, and the sag resistance and impact strength were also reduced.

In Comparative Example 6, the density of the pellet-type polyethylene resin composition prepared with a polymerization ratio of the ethylene copolymer of 58 wt % was 0.955 g/cm³, which is outside the range of the polyethylene resin composition for pipes according to one embodiment. In this case, it can be seen that the fracture time in the hydrostatic pressure test is 70 hours and thus the pipe pressure resistance is greatly deteriorated compared to Examples 1 and 2.

On the other hand, Examples 1 and 2 using the polyethylene resin composition according to one embodiment exhibit superior sag resistance and slow crack growth resistance to Comparative Examples 1 to 6, while satisfying the pipe pressure resistance, which show results that satisfy the conventional PE100 requirements.

As apparent from the afore-going, the polyethylene resin composition according to the present disclosure that has both excellent pressure resistance and slow crack growth resistance, which are contradictory properties, and exhibits high sag resistance.

The effects of the present disclosure are not limited to those described above, and other unmentioned technical effects will be apparent to those skilled in the art from the above description of exemplary embodiments.

Although the embodiments of the present disclosure have been disclosed with reference to the annexed drawings, those skilled in the art will appreciate that various modifications, additions and substitutions are possible, without departing from the scope and spirit of the disclosure. Thus, it is clear that the above-described exemplary embodiments are illustrative in all aspects and do not limit the present disclosure.

What is claimed is:

1. A polyethylene resin composition comprising an ethylene copolymer containing an ethylene monomer unit and a comonomer unit,
wherein the comonomer unit is contained in an amount of 2 wt % to 15 wt % based on a total weight of the ethylene copolymer,
the ethylene copolymer is contained in an amount of 45 wt % to 57 wt % based on the total weight of the polyethylene resin composition,
the peroxide is contained in an amount of 0.001 to 0.01 parts by weight based on 100 parts by weight of the polyethylene resin composition, and
the ethylene copolymer has a melt flow index MI21.6 (21.6 kg load, 190° C.) of 0.26 g/10 min to 0.50 g/10 min.

2. The polyethylene resin composition according to claim 1, wherein the comonomer comprises at least one of 1-butene, 1-pentene, 4-methyl-1-pentene, 1-hexene, 1-heptene, 1-octene, 1-decene, 1-undecene, 1-dodecene, 1-tetradecene, 1-hexadecene, or 1-eicosene.

3. The polyethylene resin composition according to claim 1, wherein the ethylene copolymer has a density of 0.915 g/cm³ to 0.935 g/cm³.

4. The polyethylene resin composition according to claim 1, wherein the polyethylene resin composition has a zero shear viscosity (η0) of 12,000,000 poise to 50,000, 000 poise.

5. The polyethylene resin composition according to claim 1, wherein the peroxide in the polyethylene resin composition comprises at least one selected from the group consisting of 2,5-dimethyl-2,5-di(tert-butylperoxy)hexane, 3,3,5,7,7-pentamethyl-1,2,4-trioxepane, di-tert-butyl peroxide, tert-butyl cumyl peroxide, 1,1-(tert-butylperoxy)-3,3,5-trimethylcyclohexane, n-butyl-4,4-(bis-butylperoxy) valerate, dicumyl peroxide, tert-butyl peroxide, tert-butyl peroxybenzoate, and 1,1-bis(tert-butylperoxyisopropyl)benzene.

6. The polyethylene resin composition according to claim 1, wherein the ethylene copolymer has a melt index MI5 (5 kg load, 190° C.) of 0.14 g/10 min to 0.28 g/10 min.

7. The polyethylene resin composition according to claim 1, wherein the polyethylene resin composition has a density of 0.956 g/cm³ to 0.962 g/cm³.

8. The polyethylene resin composition according to claim 1, wherein the polyethylene resin composition has a melt strength of 135 mN to 300 mN.

9. The polyethylene resin composition according to claim 1, wherein the polyethylene resin composition has a drop time of 130 seconds to 200 seconds.

10. The polyethylene resin composition according to claim 1, wherein the polyethylene resin composition has a CRB (crack round bar test, 12.5 MPa) of 1, 500,000 cycles or more.

11. The polyethylene resin composition according to claim 1, wherein the polyethylene resin composition has a strain hardening modulus of 70 MPa to 90 MPa.

12. The polyethylene resin composition according to claim 1, wherein the polyethylene resin composition in a pipe hydrostatic pressure test has a fracture time of 100 hours or more at 20° C. and 12.0 MPa.

13. The polyethylene resin composition according to claim 1, wherein the polyethylene resin composition has Charpy impact strength (−30° C.) of 10 KJ/m² to 25 KJ/m².

14. The polyethylene resin composition according to claim 1, wherein the polyethylene resin composition is used to produce a pipe.

15. A method of preparing a polyethylene resin composition comprising:
preparing a polyethylene resin composition comprising an ethylene copolymer in the presence of a catalyst using an ethylene monomer and a comonomer in a plurality of slurry polymerization reactors including a first reactor and a second reactor connected to each other;
mixing the polyethylene resin composition with an additive including peroxide; and
extruding the mixture of the polyethylene resin composition and the additive through an extruder,
wherein the comonomer unit is contained in an amount of 2 wt % to 15 wt % based on a total weight of the ethylene copolymer,
the ethylene copolymer is contained in an amount of 45 wt % to 57 wt % based on the total weight of the polyethylene resin composition,
the peroxide is contained in an amount of 0.001 to 0.01 parts by weight based on 100 parts by weight of the polyethylene resin composition, and
the ethylene copolymer has a melt flow index MI21.6 (21.6 kg load, 190° C.) of 0.26 g/10 min to 0.50 g/10 min.

16. The method according to claim 15, wherein the catalyst is a Ziegler-Natta catalyst.

17. An article produced from the polyethylene resin composition according to claim 1.

18. The article according to claim 17, wherein the article is a pipe.
